(19) United States
(12) Patent Application Publication
(10) Pub. No.: US 2006/0130633 A1
(43) Pub. Date: Jun. 22, 2006

(54) Musical instrument soundboard

(76) Inventor: Abdallah Joe Albert, Laredo, TX (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 11/354,882

(22) Filed: Feb. 16, 2006

Related U.S. Application Data
(63) Continuation of application No. 10/845,347, filed on May 14, 2004.

(51) Int. Cl. G10D 3/02

(52) U.S. Cl. 84/294

(57) ABSTRACT

A musical instrument soundboard including a resonant layer affixed to a base layer by a non-dampening acoustic coupling layer. The resonant layer can be sheets, plates, flakes, granules and powders formed of metal, crystal, glass, and ceramic. A protective layer is positioned atop the resonant layer. When formed into a musical instrument, the soundboard is highly resonant so as to provide the musical instrument with excellent tone.

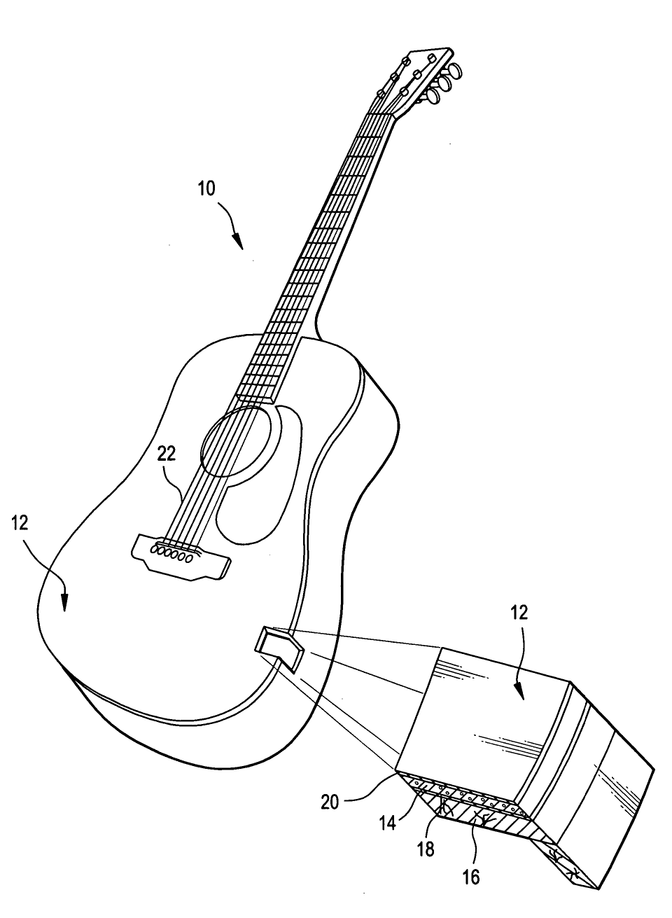

### CONTINUING APPLICATION DATA

This application is a continuation of U.S. patent application, Ser. No. 10/845,347, filed on May 14, 2004, now abandoned.

### FIELD OF THE INVENTION

The present invention relates generally to musical instruments and, more particularly, to body details thereof.

### BACKGROUND OF THE INVENTION

For centuries the makers of violins, pianos and other musical instruments have attempted to enhance the quality of the sound emitted from their instruments. These attempts have included changes in: instrument designs, construction techniques, building materials, and coatings. While many of these changes have resulted in the production of excellent musical instruments in terms of appearance and sound quality, it remains exceedingly difficult, even for the best instrument makers, to produce instruments with optimal tonal qualities. As costs of materials and labor continue to increase, only the wealthiest can expect to own the best looking and sounding musical instruments. This need not be the case, however.

### SUMMARY OF THE INVENTION

In light of the problems associated with producing musical instruments of the highest quality, it is a principal object of the invention to provide a musical instrument soundboard with both an attractive appearance and a high resonance. The soundboard responds readily to external periodic driving forces or oscillations such as those caused by vibrating strings attached to the soundboard. The soundboard increases the amplitude of the oscillations thereby producing a resonant characteristic that is pleasant to listeners.

It is another object of the invention to provide a soundboard of the type described having an attractive and durable finish.

It is a further object of the invention to provide a soundboard of the type described that can be incorporated into musical instruments of many types including, by way of example only: violins, guitars, pianos, trumpets, oboes, drums, cymbals and dulcimers.

It is an object of the invention to provide improved elements and arrangements thereof in a musical instrument soundboard for the purposes described that is lightweight in construction, inexpensive to manufacture, durable, and dependable in use.

Briefly, the musical instrument soundboard in accordance with this invention achieves the intended objects by featuring a resonant layer affixed to a base layer by an acoustic coupling layer. The resonant layer can comprise sheets, plates, flakes, granules and powders formed of metal, crystal, glass, and ceramic. A protective layer is positioned atop the resonant layer to prevent marring of the protective layer and the resulting diminution of the resonance of the soundboard.

The foregoing and other objects, features and advantages of the present invention will become readily apparent upon further review of the following detailed description of the preferred embodiment as illustrated in the accompanying drawings.

### BRIEF DESCRIPTION OF THE DRAWING

The present invention may be more readily described with reference to the accompanying drawing that is a perspective view of a musical instrument having a soundboard in accordance with the present invention, the musical instrument having a portion thereof removed and enlarged to reveal details thereof.

### DETAILED DESCRIPTION OF THE PREFERRED EMBODIMENT

Referring now to the drawing, a musical instrument in the form of a guitar 10 is shown to have a soundboard 12 in accordance with the present invention. Soundboard 12 includes a resonant layer 14 affixed to a base layer 16 by an acoustic coupling layer 18. A protective layer 20 is positioned atop resonant layer 14. When incorporated into musical instrument 10, soundboard 12 provides instrument 10 with optimal sound production capabilities.

Base layer 16 can be formed from any material known in the art for constructing a musical instrument. Such materials can include, by way of example: wood, metal, fiberglass, plastic, carbon fiber composite, bone, and animal hide. These materials can be used singly or can be laminated or otherwise pieced together as a manufacturer may desire. Furthermore, the dimensions of base layer 16 are a matter of design choice. Thus, base layer 16 can be a planar piece of spruce with two bouts connected by a narrow waist for use as the top of musical instrument 10 or it could be the coiled metallic tube that is the body of a trumpet (not shown). The possibilities are limitless.

Should wood be employed to construct base layer 16, it is preferably dried to limit subsequent shrinking, checking and cracking. Wood can be quickly dried in a kiln or more slowly dried by prolonged exposure to air. The application of supercritical fluids, such as carbon dioxide, to wood can also have a dehydrating effect. Of course, the use of these or any other dehydrants is within the discretion of the musical instrument manufacturer.

Acoustic coupling layer 18 is applied by brushing, spraying, pouring, or otherwise positioning it upon base layer 16. Although acoustic coupling layer 18 is shown positioned atop base layer 16 in the drawing, this is for the sake of convenience only as coupling layer 18 can be applied to any and all sides of base layer 16. Preferably, acoustic coupling layer 18 comprises an oil or comprises an acoustic coupling gel that is compatible with base layer 16. Alternatively, acoustic coupling layer 18 can comprise adhesive cement. Acoustic coupling layer 18 can, in terms of phase, be a solid, semi-solid or liquid in the completed soundboard 12, such being a matter of design choice.

Resonant layer 14 is positioned atop acoustic coupling layer 18 and is bonded by acoustic coupling layer 18 to base layer 16 so that layers 14, 16 and 18 oscillate in response to external periodic driving forces. Resonant layer 14 can be formed from a variety of solid materials including, but not limited to: metals (crystal, single crystal, glassy, and amorphous) like magnesium, aluminum or bell bronze; crystals like garnet; glass; leaded glass; mixed glass; and ceramics. Combinations of these materials can also be formed so that resonant layer 14 comprises: metals with ceramics or glassy metals with ceramics or amorphous metals with ceramics or metals with crystals or glassy metals with crystals or amorphous metals with crystals or metals with single crystals or ceramics with single crystals or glassy metals with single crystals. The materials from which resonant layer 14 is formed can be in the form of: sheets, plates, flakes, and finely divided aggregates and powders of varying particle size. For ease in applying a resonant layer 14 comprising small particles atop acoustic coupling layer 18, the particles can be applied as a suspension in an evaporative liquid analogous to the liquid component of paint.

Protective layer 20 is positioned atop resonant layer 14 to prevent the marring of resonant layer 14. Preferably, protective layer 20 is a coating of varnish or other material compatible with base layer 16, acoustic coupling layer 18 and resonant layer 14. It is anticipated that protective layer 20, will be thin, on the order of a few thousandths of an inch, so as to not appreciably reduce the resonance of soundboard 12. If resonant layer 14 is sufficiently durable in its initial construction, as might be the case if resonant layer 14 comprises a glass plate or a metallic sheet, protective layer 20 can be omitted from soundboard 12.

From the foregoing, it should be appreciated that soundboard 12 is uncomplicated to construct and can be readily incorporated into the manufacture of numerous types of musical instruments. For example, in the construction of musical instrument 10, base layer 16 is a thin sheet of spruce. Upon the top of spruce sheet 16 is sprayed a liquid adhesive cement, i.e., acoustic coupling layer 18, upon which is positioned, before the cement has cured, resonant layer 14 comprising aluminum powder. After the adhesive comprising acoustic coupling layer 18 has set and the aluminum powder comprising resonant layer 14 is affixed to the spruce sheet comprising base layer 16, protective layer 20 of varnish is sprayed. Once the varnish comprising protective layer 20 has set, and strings 22 capable of applying external periodic driving forces or oscillations are attached to soundboard 12, strings 22 are plucked to oscillate them. Soundboard 12 increases the amplitude of the oscillations of strings 10 producing a resonant characteristic in air that is pleasant to nearby listeners. The resonance and tonal characteristics of soundboard 12 will be noted to be markedly better than an instrument 10 constructed in a conventional manner.

While the invention has been described with a high degree of particularity, it will be appreciated by those skilled in the art that modifications may be made thereto. For example, it may be possible to incorporate more than one acoustic coupling layer 18 and resonant layer 14 into soundboard 12, stacking them in the manner of a layer cake, to further enhance the resonant qualities of a soundboard. Therefore, it is to be understood that the present invention is not limited to the sole embodiment described above, but encompasses any and all embodiments within the scope of the following claims.

I claim:

1. A musical instrument soundboard, comprising:
a wooden base layer;
a non-dampening acoustic coupling layer being positioned atop said base layer, said acoustic coupling layer being selected from the group consisting of an oil and an acoustic coupling gel;
a resonant layer being positioned atop the acoustic coupling layer, said resonant layer being selected from the group consisting of metal, crystal, glass, and ceramic;
and, a protective layer being positioned atop said resonant layer.

2. The soundboard according to claim 1 wherein said base layer is a planar sheet.

3. The soundboard according to claim 1 wherein said acoustic coupling layer is coextensive with said base layer.

4. The soundboard according to claim 3 wherein said resonant layer is coextensive with said acoustic coupling layer.

5. The soundboard according to claim 1 wherein said resonant layer is a plurality of plates being positioned side by side and being capable of independent vibratory motion.

6. The soundboard according to claim 1 wherein said resonant layer is a plurality of flakes.

7. The soundboard according to claim 1 wherein said resonant layer is a film of powder.

8. The soundboard according to claim 8 wherein said protective layer comprises varnish.

9. A musical instrument, comprising:
a soundboard including:
a base layer;
a non-dampening acoustic coupling layer being positioned atop said base layer, said acoustic coupling layer being selected from the group consisting of an oil and an acoustic coupling gel;
a resonant layer being positioned atop the acoustic coupling layer, said resonant layer being selected from the group consisting of metal, crystal, glass, and ceramic; and,
a protective layer being positioned atop said resonant layer; and, a plurality of taut strings being attached to said soundboard serving as a source of
external periodic driving forces when moved.
